(19) United States
(12) Patent Application Publication
(10) Pub. No.: US 2011/0058683 A1
(43) Pub. Date: Mar. 10, 2011

(54) METHOD & APPARATUS FOR SELECTING A MICROPHONE IN A MICROPHONE ARRAY

(76) Inventors: GLENN KOSTEVA, Westford, MA (US); Timothy Root, Nashua, NH (US); Vladimir Botchev, Nashua, NH (US)

(21) Appl. No.: 12/554,024

(22) Filed: Sep. 4, 2009

(51) Int. Cl. H04R 3/00

(52) U.S. Cl. 381/92

(57) ABSTRACT

A mobile robotic device includes a microphone array for detecting sound energy in its immediate environment. The sound energy received by each microphone in the microphone array is digitized, sampled and quantified. The quantified sound energy is used to calculate a sound energy difference factor between neighboring microphones in the array, the sound energy difference factors calculated over time are counted to be greater than or lesser than a nominal value and the counts are used to calculate a series of two-dimensional sound energy factors. The output of the microphone with the two highest calculated two-dimensional energy factors is then selected for processing and transmission over a network to be played at a far-end location.

### FIELD OF INVENTION

The present invention relates to the detection of an audio signal external to a mobile robotic platform. More specifically, the present invention relates to the detection of sound energy in order to select a microphone in an array of microphones.

### BACKGROUND

An array of directional microphones can be employed in communication applications, such as in audio conferencing, where hi-quality audio and the location of an audio source is to be determined is desirable. Such an array of directional microphones can send the sound signals they receive to signal processing functionality to determine the location of the sound source or sources and then employ complex algorithms to form a beam in the direction of the sound source. Typically, the location of the sound source is estimated using a time-delay-of-arrival based SSL (sound source location) technique. One such technique is described in U.S. Pat. No. 7,305,096 (Rui) assigned to the Microsoft Corporation.

In recent years, mobile robotic devices have been developed that include communication applications such as audio and video conferencing so that users of the device can communicate with communication devices that are remote to it. To support such communication applications, the robotic device typically includes one or more microphones to receive audio information from its environment, a camera to receive video information from its environment and one or more speakers to play audio which is typically received from a remote communications device. When interacting with a robotic device for the purpose of communicating with a remote communication device, it is often important that the microphones included on the robotic device be oriented to be in the best/optimum position for receiving sound information. This can be accomplished by detecting the location of a sound source and rotating the robotic device so that its microphones are in an optimum position or by manipulating the gain of two or more microphones arranged in an array to form a beam that is directed to the location of the sound source. A method for estimating the location of a sound source relative to a microphone array included in a mobile robotic device is described in U.S. Pat. No. 7,227,960 (Kataoka). Column 1, line 42—column 2, line 22 in Kataoka describes how a time difference in signals captured by a plurality of microphones can be utilized to estimate the direction of a sound source.

Audio conferencing devices exist that employ an array of three or more microphones to receive sound energy in a three hundred sixty degree radius with respect to the device. However, all known audio conferencing devices with a capability to receive sound energy in a three hundred sixty degree radius and with the capability to localize the source of sound energy are expensive and complicated (algorithms requiring hi CPU utilization) to implement and so are typically only found in hi-end audio or video conferencing systems. It would be beneficial if a simpler and less expensive solution existed for receiving sound energy in a three hundred sixty degree radius and for localizing the source of the sound. The market for audio communication applications could be expanded if a hi-quality, low cost audio conferencing design existed. Further, it would be advantageous to include such a hi-quality, low cost audio conferencing arrangement in a mobile robotic device.

### SUMMARY

In one embodiment, a sound energy detector selection method is comprised of receiving sound energy at a sound energy detector array from at least one sound energy source; digitizing the sound energy output of each of the sound energy detectors in the array; sampling and quantifying the digitized sound energy associated with each of the sound energy detectors in the array; and using a calculated difference in the quantified sound energy between pairs of neighboring detectors in the array to select at least one detector in the array to receive sound energy from the at least one sound energy source.

### BRIEF DESCRIPTION OF DRAWINGS

FIG. 1 is a diagram showing a microphone array.

FIG. 2 is a diagram showing the functional blocks comprising a microphone selection apparatus of the invention.

FIG. 3 is a logical flow diagram of one embodiment of the invention.

### DETAILED DESCRIPTION

With the advent of the current personal communications revolution, many different classes of communication devices are now available that incorporation some combination of audio, video, text messaging and other multimedia communication applications on a single device. Many of these communication devices are small, easily portable devices that are carried around by an individual, while other devices are less portable and may be positioned on a desk top for instance. Unfortunately, most portable communication devices are necessarily small, and so it is problematic to incorporate sophisticated audio and/or video communication capabilities in such a device. One class of communication device that can include all of the above listed communication applications and which is typically not suited for portability is a mobile robotic device. Such a device can move autonomously in its environment, move under remote control or both Mobile robotic devices are currently available which support sophisticated audio communications and/or video communications applications suitable for use by one or more individuals proximate to the robotic device. In the event that audio conferencing capability is included in a mobile robotic device, it is convenient if the robotic device include a microphone array capable of receiving sound energy (speech) in a three hundred sixty degree radius with respect to it. With a three hundred sixty degree microphone array, it may not be necessary for the robotic device to position itself so that one or more microphones are directed toward the source of the sound energy. Unfortunately, prior art methods for selecting the optimum microphone(s) in an array of at least two microphones require relatively complicated algorithms and too much processing time and processing power which unnecessarily raises the cost of a mobile robotic device which includes sophisticated communications applications. In order to solve this problem, a simple and inexpensive microphone selection method and apparatus are described here that is able to quickly and accurately select at least one microphone, from among an array of two or more microphones and to seamlessly (from the perspective of an individual listening to the audio play at a far end device) select at least a second microphone in the array in the event that the sound source moves in order to continuously optimize the reception of sound from a sound source proximate to the mobile robotic device.

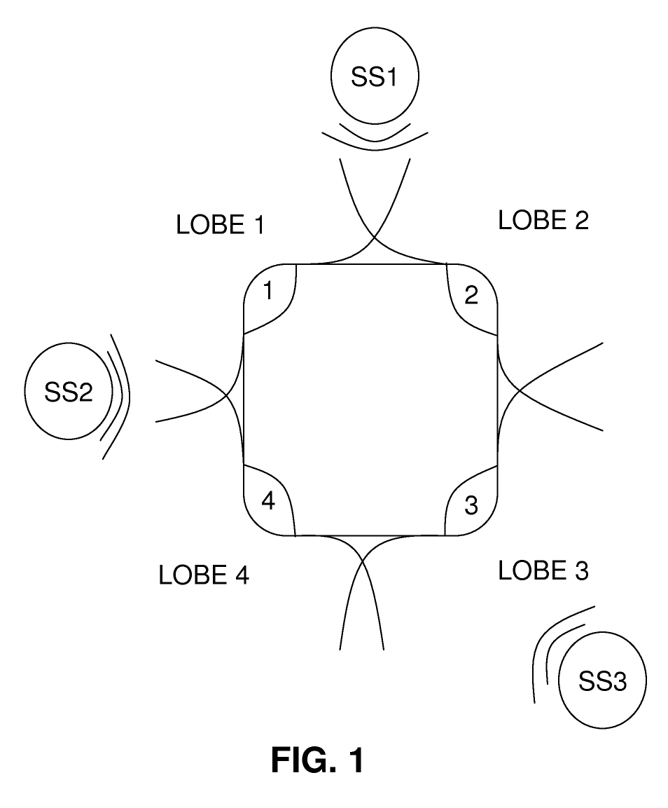

FIG. 1 is a diagram of a representative microphone array 21 which in this case includes four microphones, labeled mic. 1, mic. 2, mic. 3 and mic. 4. Fewer or more microphones can be incorporated into the microphone array depending upon the application and the desirability of seamlessly transferring the reception of sound from one microphone in the array to another. The array 21 described herein includes four microphones as this is the preferred embodiment for the mobile robotic device in which the novel microphone selection method is implemented. However, the array can also be incorporated into an audio and/or video conferencing device. Each of the four microphones can be uni-directional microphones which are typically referred to as cardioid microphones. A uni-directional microphone is sensitive to sound coming from one direction at some angle which is typically one hundred eighty degrees or less. The polar pattern of a uni-directional microphone indicates the sensitivity of the microphone to sound arriving at different angles about its central axis. In this case, each microphone 1-4 has a respective lobe or beam 1-4 which indicates the polar pattern of each microphone. The polar pattern for each microphone can be substantially the same or it can be different; however, in this case the polar patterns of each microphone are substantially the same. The four microphones 1-4 are preferably arranged in a horizontal plane, ninety degrees from each other around a central point and at a height that optimizes the reception of targeted sound energy, which in this case is human speech. Also included in FIG. 1 are three sound sources, SS1, SS2 and SS3 which in this case represent the locations of sound sources.

There are several advantages to the microphone selection method described herein. One advantage is that low cost microphones can be used which do not need to be closely matched, one to the other, for gain/sensitivity. Another advantage of this method is that it does not use complex frequency domain translation and analysis which require a large number of calculations which use processing time which can otherwise be used for other tasks.

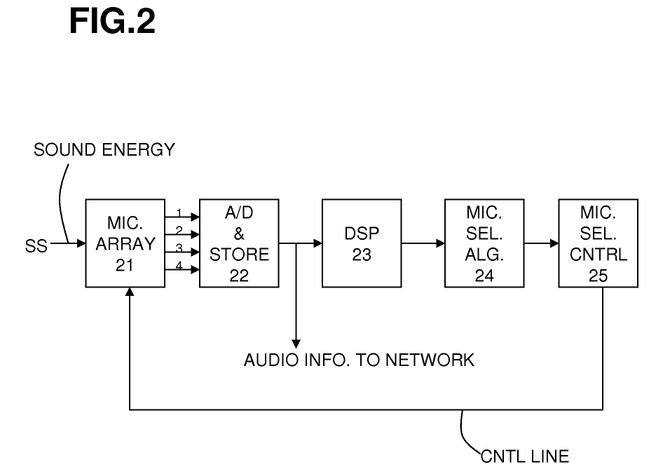

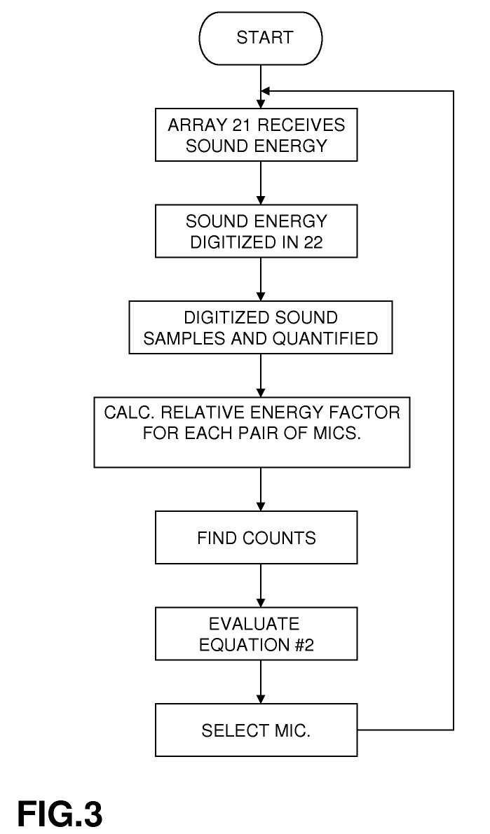

FIG. 2 is a block diagram showing the functional elements that can be employed to practice the novel microphone selection method described here. A sound source (SS) is shown which emits sound energy that is directed to a microphone array 21 which is comprised of four microphones, mic. 1-4. One or more of the microphones in the array 21 receive the sound energy and convert the sound energy to an analog waveform before sending it to an analog to digital converter (A/D) 22, where the analog waveform information is converted to digital sound energy information. The digitized sound energy information can then be stored and is available for further processing in audio processing block 23 (DSP for instance) to quantify the sound energy in the time domain, or the digital sound information can be sent, over a network, to a remote communication device to be played. Processing sound energy to quantify the amount of sound energy received over time is well known to audio engineers and so will not be discussed here in any detail, but generally, the processing block 23 is configured to sample digitized sound energy information over some predetermined sampling interval, which in this case can be 20 msec, at a sample rate of 16 KHz for instance (the sampling rate can be greater or lesser that 16 KHz depending upon the desired audio fidelity). Accordingly, each interval represents 320 samples of sound energy information with each sample equal to 62.5 usec. Each 20 msec interval is processed by block 23 to quantify the amount of sound energy for the 20 msec interval and the sound energy information associated with each microphone in the array 21 can be stored for later use by the microphone selection algorithm. Functional block 24 can include, among other things, a microphone selection algorithm. A detailed description of the operation of the microphone selection algorithm to identify the location of a sound source and select a microphone will be described later with reference to FIG. 3. However, in general, the microphone selection algorithm uses the stored sound energy information associated with each microphone to calculate a relative energy factor which is comprised of the relative voice or sound energy between any two neighboring microphones in the microphone array 21, such as between mic. 1 and mic. 2, mic. 2 and mic. 3, mic. 3 and mic. 4 or between mice. 4 and mic. 1. The microphone that is calculated to receive the highest level of sound energy, as compared to all the other microphones in the array 21, is assumed to be in the best position to receive sound from a source (i.e., is assumed to be closest to the microphone or in the best position, acoustically, to receive the sound and so is selected to receive the sound). The outputs from the remaining microphones in the array 21 can be turned off or their gain can be attenuated. All of the calculated, relative sound energy factors can be stored in microphone selection FIFO 25 where they can be used by a microphone selection control function to select one or more of the microphones (1-4) in the microphone array 21.

Continuing to refer to FIG. 2, the microphone selection algorithm, which is implemented in functional block 24, can track or count the number of times a relative energy factor (U) for a pair of neighboring microphones in the array 21 is calculated to be greater than or less than zero or some reference value over a predetermined period of time which is referred to here as the predetermined evaluation period or simply evaluation period (each evaluation period is composed of one or more sampling intervals). Given two microphones, microphone 1 and 2 for example, if the relative energy factor is calculated to be greater than zero, then this is an indication that microphone 1 is receiving more sound energy than microphone 2. The algorithm then uses the relative energy factor counts to calculate which of at least one of the microphones in the array 21 receives the most sound energy. The relative sound energy between two neighboring microphones in array 21 is calculated by summing, over the predetermined evaluation period, quantified sound energy associated with one of the microphones in the array 21, microphone 1 for example, and comparing the resultant sound energy to the summed, resultant sound level energy calculated for either microphone 2 or microphone 4. Equation 1, below, is used to calculate a relative sound energy factor between two neighboring microphones.

U_{xy}(i)=Σ|(Sₓ(j))|−(S_{y}(j)) Equation 1

where:
U_{xy}=relative energy factor between two neighboring microphones x and y.
S=Sound energy level for one sample
j=number of samples per period
i=number of periods
x=a first microphone element
y=a second microphone element that is a neighbor with respect to the first microphone element.
   The result of this calculation is a positive or negative relative energy factor value between two neighboring microphones that can be used to select the optimum microphone in the array 21. For example, if the sampling frequency of the signal processing in functional block 23 is 16 KHz, then the value of the number of samples (j) in Equation 1 is set to 320. If sound energy samples are collected for three periods (evaluation period) between microphone selection events, than the number of periods (i) in Equation 1 is set to three. For example, given that the relative energy factor U is being evaluated for x=microphone number 1 and y=microphone number 2, and the absolute value of the sum of the sound energy level over the evaluation period, or 960 samples for microphone 1, is equal to 9.0×10⁶ joules and the absolute value of the sum of the sound energy level over the evaluation period, or 960 samples for microphone 2, is equal to 5.0×10³ joules. In this case, the resultant value for U_{xy}(i), which is 8.99×10⁶ joules, is a value that is greater than zero. In the preferred embodiment, the values of U_{xy} that are calculated to be equal to zero are ignored. Each time Equation 1 is evaluated for U_{xy}, the resultant relative energy factor value is determined to be either greater than zero or less than zero. During each evaluation period, the number of times that the value of U_{xy} is less than zero (It) is “counted” and stored as a first sub-set of counts and the number of times that the value of U_{xy} is greater than zero (gt) is “counted” and stored as a second sub-set of counts. The first and second sub-sets of counts, referred to herein as a count set, can be associated with the pair of neighboring microphones 1 and 2, for example. Each of the pairs of microphones, in this case four pairs, is associated with a different count set and each different stored count set is employed by the microphone selection algorithm to calculate which of at least one of the microphones in the array 21 receives the most sound energy as described below with reference to Equation 2.

Equation 2, below, is employed by the microphone selection algorithm to calculate a two dimensional sound energy factor for each microphone in the array 21. The results of the calculations are used to select which of the microphones in the array receives the most sound energy over evaluation period.

U_{2D}(N)=gt(U_{xy}(i))·lt(U_{xy}(i)) Equation 2

Where
N=one of the microphones in the array 21
gt=greater than zero count
lt−less than zero count
U_{xy}(i))=relative energy factor for a first microphone x and a second neighbor microphone y for period (i)
   The microphone selection algorithm, for each sampling period (i), uses the stored set of counts (gt and lt) associated with each relative energy factor U_{xy}, with xy representing one of four microphone pairs in the array 21 of four microphones, to calculate a two dimensional sound energy factor U_{2D}. For each microphone in array 21, a separate two dimensional sound energy factor is calculated between it and each one of its two neighboring microphones. So for example, if microphone 1 is selected, then microphone 2 and microphone 4 are the two neighboring microphones. More specifically, the microphone selection algorithm can use the count set associated with microphones 1 and 2 for a first calculation and the count set associated with microphones 1 and 4 for a second calculation. The first and second two dimensional energy factors calculated for each of the four microphones are stored, and the microphone selection and control functionality in block 25 of FIG. 2 is employed to select the microphone which is associated with or common to the two highest calculated two dimensional energy factors.

The microphone selection algorithm will now be described with respect to the logical flow diagram in FIG. 3. In step 1, the microphone array 21 receives sound energy from a sound source, such as SS#3 in FIG. 1, and the sound energy received by each of the four microphones is, in step 2, sent to the A/D converter 22 of FIG. 2 where the sound energy for each microphone is converted from analog information to digital information. In step 3, the digitized sound energy information associated with each microphone is sampled and quantified by the digital signal processing functionality in block 23 of FIG. 2. The quantified sound energy is then stored. In step 4, Equation 1 is evaluated to determine the relative energy factor U_{xy} between each of a set of two neighboring microphones in the array 21. In this case, there are four sets of neighboring microphones in the array used in the evaluation of Equation 1. As described earlier with reference to FIG. 2, the microphone selection algorithm uses the stored, quantified sound energy information associated with each microphone to calculate a relative energy factor which is comprised of the relative voice or sound energy level between any two neighboring microphones in the microphone array 21. Then, in step 5, during each evaluation period, the number of times that the value of U_{xy} is less than zero is “counted” and stored as a first sub-set of counts and the number of times that the value of U_{xy} is greater than zero is “counted” and stored as a second sub-set of counts. The first and second sub-sets of counts or count set can be associated with a pair of neighboring microphones. Each of the pairs of microphones is associated with a different count set and each different stored count set is employed by the microphone selection algorithm to, in step 6, calculate which of at least one of the microphones in the array 21 receives the most sound energy. The Equation 2 described earlier is used in these calculations and the results of these calculations can be stored in memory included in block 25 of FIG. 2. The microphone associated with the two highest calculated two dimensional energy factors is selected by the microphone selection algorithm, from among all of the microphones in the array 21, to receive all or substantially all of the sound energy currently arriving at the array 21. Substantially all in this case indicates that more than ninety percent of the sound energy arriving at array 21 is received by the detector. The other microphones in the array 21 can be effectively switched off which can be effected by attenuating their outputs. According to the embodiment described with reference to FIG. 3, the sound energy from the environment surrounding the microphone array 21 is continually sampled and evaluated to determine the highest two-dimensional energy factor over the evaluation period, after which at least one microphone output is selected for sound energy evaluation. Another evaluation period begins immediately at the end of the last evaluation period so that a series of uninterrupted evaluation periods are run without any interruption in the sound energy evaluation.

In another embodiment, the microphone selection algorithm can be implemented to delay the start of each evaluation period. In this case, the microphone that is selected as the result of the last evaluation period is not changed until another, delayed evaluation period is run and another two-dimensional energy factors is calculated. The delay between evaluation periods can be smaller or larger depending upon the environment in which the microphone array 21 is located. This embodiment can be employed when the microphone array 21 is positioned in an environment in which a sound energy source is not moving rapidly around the environment or is stationary. By delaying the start of the next evaluation period, processing resources can be made available for other applications and/or less expensive processing devices can be used. This embodiment also has the effect of smoothing out the switching transitions and reducing the impact of spurious noise sources or surrounding noise.

In another embodiment, the microphone selection algorithm continually calculates the relative energy factors, U_{xy}(i), and then integrates the two dimensional energy factors over a programmable number of intervals k. While this requires a more sophisticated and costly processing device to perform, the result is a more gradual smoothing affect and more accurate microphone switching response.

The forgoing description, for purposes of explanation, used specific nomenclature to provide a thorough understanding of the invention. However, it will be apparent to one skilled in the art that specific details are not required in order to practice the invention. Thus, the forgoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

We claim:

1. A method for selecting a sound energy detector, comprising:
receiving sound energy at a sound energy detector array from at least one sound energy source;
digitizing the sound energy output associated with each of the plurality of detectors in the array;
sampling and quantifying the digitized sound energy associated with each of the plurality of detectors in the array;
summing the quantified sound energy for each detector in the array over one or more evaluation periods and subtracting the summation of the sound energy associated with a first detector for a first one of the one or more evaluation periods from the summed sound energy associated with a neighboring second detector for the first one of the one or more evaluation periods which subtraction operation results in a relative sound energy value between the first and second detectors for the first one of the one or more evaluation periods;
determining whether the resultant relative sound energy value for each of the one or more evaluation periods is greater than or less than zero, counting each instance of the sound energy value that is greater and zero and storing the result as a first count sub-set and counting each instance of the sound energy value that is less than zero and storing the resultant count as a second count sub-set;
using the first and second count sub-sets to calculate a two-dimensional sound energy factor value for each detector in the detector array; and
selecting a detector that is common to the two highest calculated two-dimensional sound energy factor values to receive substantially all of the sound energy arriving at the detector array from the sound energy source.

2. The method of claim 1 wherein the sound energy detectors are microphones.

3. The method of claim 1 wherein the sound energy detector array is comprised of at least two sound energy detectors.

4. The method of claim 1 wherein the digitized sound energy is sampled over one or more intervals.

5. The method of claim 1 wherein the evaluation period is composed of one or more sampling intervals.

6. A method for selecting a sound energy detector, comprising:
receiving sound energy at a sound energy detector array from at least one sound energy source;
digitizing the sound energy output of each of the sound energy detectors in the array;
sampling and quantifying the digitized sound energy associated with each of the sound energy detectors in the array; and
using a calculated difference in the quantified sound energy between pairs of neighboring detectors in the array to select at least one detector in the array to receive sound energy from the at least one sound energy source.

7. The method of claim 6 wherein the sound energy detector is a microphone.

8. The method of claim 6 wherein the sound energy detector array is composed of at least two sound energy detectors.

9. The method of claim 6 wherein the digitized sound energy is sampled and quantified over an interval.

10. The method of claim 6 wherein the difference in the quantified sound energy between pairs of neighboring detectors in the array is calculated by subtracting the summation of the sound energy associated with a first sound energy detector in the array for a first one of one or more evaluation periods from the summed sound energy associated with a neighboring second sound energy detector in the array for the first one of the one or more evaluation periods.

11. The method of claim 10 wherein the evaluation period is composed of one or more sampling intervals.

12. The method of claim 6 wherein the at least one detector is selected by calculating a relative sound energy value for pairs of neighboring sound energy detectors in the array, determining whether the resultant relative sound energy value for each of the one or more evaluation periods is greater than or less than zero, counting each instance of the sound energy value that is greater than zero and storing the result as a first count sub-set and counting each instance of the sound energy value that is less than zero and storing the resultant count as a second count sub-set, using the first and second count sub-sets to calculate a two-dimensional sound energy factor value for each sound energy detector in the detector array; and selecting a sound energy detector that is common to the two highest two-dimensional sound energy factor values to receive substantially all of the sound energy arriving at the detector array from the sound energy source.

13. An apparatus for selecting a sound energy detector, comprising:
a sound energy detector array;
an analog to digital converter for digitizing sound energy output by the detector array;
a digital signal processor for sampling and quantifying the digitized sound energy; and
means for calculating a difference in the quantified sound energy between pairs of neighboring sound energy detectors in the array to select at least one sound energy detector in the array to receive sound energy from the at least one sound energy source.

13. The apparatus of claim 12 wherein the sound energy detector is a microphone.

14. The apparatus of claim 12 wherein the sound energy detector array is composed of at least two sound energy detectors.

15. The apparatus of claim 12 wherein the digital signal processor samples and quantifies the digitized sound energy over an interval.

16. The apparatus of claim 12 wherein the means for calculating a difference in the quantified sound energy between pairs of neighboring sound energy detectors in the array subtracts the summation of the sound energy associated with a first sound energy detector in the array for a first one of one or more evaluation periods from the summed sound energy associated with a neighboring second sound energy detector in the array for the first one of the one or more evaluation periods

17. The apparatus of claim 16 wherein the evaluation period is composed of one or more sampling intervals.

18. The apparatus of claim 12 wherein the means for calculating a difference in the quantified sound energy between pairs of neighboring sound energy detectors in the array to select at least one sound energy detector in the array to receive sound energy from the at least one sound energy source calculates a relative sound energy value for pairs of neighboring sound energy detectors, determines whether the resultant relative sound energy value for each of the one or more evaluation periods is greater than or less than zero, counts each instance of the sound energy value that is greater than zero and stores the result as a first count sub-set and counts each instance of the sound energy value that is less than zero and stores the resultant count as a second count sub-set, uses the first and second count sub-sets to calculate a two-dimensional sound energy factor for each sound energy detector in the detector array; and selects a sound energy detector that is common to the two highest two-dimensional sound energy factor values to receive substantially all of the sound energy arriving at the detector array from the sound energy source.
